(19) United States
(12) Patent Application Publication
(10) Pub. No.: US 2010/0023319 A1
(43) Pub. Date: Jan. 28, 2010

(54) MODEL-DRIVEN FEEDBACK FOR ANNOTATION

(75) Inventors: DANIEL M. BIKEL, MOUNT KISCO, NY (US); VITTORIO CASTELLI, CROTON ON HUDSON, NY (US)

Correspondence Address: TUTUNJIAN & BITETTO, P.C., 20 CROSSWAYS PARK NORTH, SUITE 210, WOODBURY, NY, 11797, US

(73) Assignee: INTERNATIONAL BUSINESS MACHINES CORPORATION, ARMONK, NY (US)

(21) Appl. No.: 12/180,951

(22) Filed: Jul. 28, 2008

(51) Int. Cl. G06F 17/27

(52) U.S. Cl. 704/9

(57) ABSTRACT

A system, a method and a computer readable media for providing model-driven feedback to human annotators. In one exemplary embodiment, the method includes manually annotating an initial small dataset. The method further includes training an initial model using said annotated dataset. The method further includes comparing the annotations produced by the model with the annotations produced by the annotator. The method further includes notifying the annotator of discrepancies between the annotations and the predictions of the model. The method further includes allowing the annotator to modify the annotations if appropriate. The method further includes updating the model with the data annotated by the annotator.

### GOVERNMENT RIGHTS

This invention was made with Government support under Contract No.: HR0011-06-2-0001 awarded by the Defense Advanced Research Projects Agency (DARPA). The Government has certain rights in this invention.

### BACKGROUND

1. Technical Field

This application relates to a system, a method, and a computer readable media for annotating natural language corpora.

2. Description of the Related Art

Modern computational linguistics, machine translation, and speech processing heavily rely on large, manually annotated corpora.

A survey of related art includes the following references. An example of a natural language understanding application can be seen in U.S. Pat. No. 7,191,119. An example of nearest neighbor norms can be seen in the following paper, by Belur V. Dasarathy, editor (1991) Nearest Neighbor (NN) Norms: AN Pattern Classification Techniques, ISBN 0-8186-8930-7. A discussion of machine learning can be seen in the article by Yoav Freund and Robert E. Schapire, entitled Large Margin Classification Using the Perceptron Algorithm, in Machine Learning, 37(3), 1999. A discussion of Bayes classification schemes can be found in the article An empirical study of the naive Bayes classifier, from the IJCAI 2001 Workshop on Empirical Methods in Artificial Intelligence, by Irina Rish (2001).

Annotated corpora are used to guide the manual creation of computer models, to train automatically generated computer models, and to validate computer models. For example, consider a parser, that is, an automatic program that extracts the grammatical structure of sentences in a document. A simple parser consists of a collection of production rules, which describe the grammar of the language, plus a set of meta-rules, which describe how the production rules should be applied in a data-driven fashion. Meta-rules are necessary because a brute-force approach that applies all possible collections of production rules and selects the best candidate set is computationally unfeasible. A common way of constructing parsers consists of manually generating production rules and inferring some or all the meta-rules from an annotated corpus (in this case, the corpus would be a tree-bank, i.e., a collection of manually parsed documents—where each sentence is accompanied by its manually-assigned parse tree).

The Computer Science discipline that studies how to automatically infer algorithms or rules from data is called Machine Learning. Machine learning often based on statistical principles, and therefore intersects with a field of statistics called Statistical Pattern Recognition. Machine learning is often concerned with how to extract information from very large collections of data, and therefore intersects with another field of Computer Science called Data Mining. Machine learning, statistical pattern recognition, and data mining are widely known disciplines.

For the purposes of the present invention, we will use the terms computer model, statistical model, or simply model to denote the type of algorithms and rules produced by machine learning techniques, including, for example, automatic classifiers and algorithms for the various types of computational linguistics, natural language processing, speech processing, etc., that are of direct relevance to the present invention.

Models are automatically produced from the data by programs called learning algorithms, or learners. The process of automatically producing an algorithm or rules is called learning, or, sometimes, training. The data used by the learning algorithm is called training set. In specific disciplines, other names are used interchangeably: for example, in the application fields of interest of the present invention, the term annotated corpus is often encountered in lieu of training set.

For the purposes of the present invention, we can distinguish two main approaches to the inference of models from data. The first is called batch learning and consists of first collecting the data and then analyzing it. The second is called online learning or incremental learning and consists of constructing models by incrementally modifying them, where modifications are triggered by the availability of new data. Efficient algorithms for incremental learning have been developed and are well known in the art. Irrespective of how models are generated, the quality of the result is highly dependent on the quality of the available data. Machine learning for natural language processing applications is not an exception to the rule.

Given the complexity of natural languages, large annotated corpora are typically required to produce effective models. Since annotation is a manual process, creating a large annotated corpus is an expensive and time-consuming endeavor, which typically involves the work of multiple human annotators.

Manual annotation is an inherently noisy process: not only do different annotators often produce different annotations of the same document fragment, but each annotator can produce inconsistent annotations.

Annotation mistakes have different causes, such as distraction and fatigue or ambiguous descriptions of the annotation task. Furthermore, the fact that the description of the annotation task is perforce underspecified can cause annotators to make mistakes. Inconsistencies between different annotators arise because of different experience levels and because of variations on how the annotator task is interpreted. Finally, individual annotators can produce inconsistent annotations because their interpretation of the task evolves over time.

Annotation mistakes and inconsistencies negatively affect the quality of the models produced with the annotation data. Two main classes of strategies exist to reduce annotation errors and inconsistencies, which are described below, together with their main limitations.

The first category of strategies to reduce annotation inconsistencies and error is based on task replication. Multiple annotators are tasked with annotating the same data; differences in annotations are manually resolved either by a committee composed of all or some of the annotators, or by an expert. The main advantage of these methods is that they typically produce high-quality data. The main limitation of the task replication approaches is, clearly, the cost, since multiple annotators perform the same task.

The second category of strategies to reduce annotation inconsistencies are based on the correction mode of annotation: an initial computer model is constructed by carefully annotating a small fraction of the corpus. The model is then applied to the corpus to automatically produce annotations. Automatically annotated documents are then presented to the annotators who are asked to correct the mistakes made by the system. The main advantage of the correction mode strategies is that different annotators are tasked with annotating different documents; also, annotators can be more efficient, since they only need to actually produce annotations when the initial computer model makes mistakes. The first main limitation of the correction mode strategies is the fact that the initial model can bias the annotators' judgment, and therefore annotators who implicitly trust the model might produce different annotations than in other annotation modes; this is a potential cause of errors because the initial computer model is generated with a small amount of data and therefore typically performs poorly on data whose annotation is non-trivial. The second main limitation is that errors due to fatigue or distraction typically are not mitigated by these approaches, and can actually be amplified because annotators might overlook mistakes made by the original computer model even in cases in which they would have produced correct annotations.

Accordingly, the inventors herein have recognized a need for an improved system, method, and computer readable media for supporting annotation of corpora for computational linguistics, speech recognition, machine translation, and related fields.

### SUMMARY OF INVENTION

A method for annotating corpora for computational linguistics, speech recognition, machine translation, and related fields, in accordance with an exemplary embodiment is provided. The method includes connecting the annotation tool used by annotators to an online learning algorithm. The method further includes incrementally training a model by feeding the annotations produced by the annotator to the learning algorithm. The method further includes using the single, automatic trained model to produce annotations for data that the annotator still needs to annotate. Different parts of the corpus are provided to multiple human annotators to preform annotations thereof. The method further comprises comparing the result of the next annotation produced by the annotator with the annotation produced by the model. The method further comprises notifying the annotator of a possible inconsistency or mistake when the annotations produced by the annotator and by the model are different. The method further comprises providing UT elements for notifying the annotator of the possible mistake. The method further comprises notifying the annotator of a possible inconsistency or mistake when the annotations produced by the annotator and by the model are different and when the confidence of the model on its produced annotation is sufficiently high. The method further comprises providing a UT control for the annotator to tune a confidence threshold below which possible inconsistencies and mistakes are not flagged and above which they are flagged. Each human annotator is allowed to review and independently revise the inconsistency identified by the automatic model. The model is updated base on the revisions and is immediately made available to all human annotators.

A system for annotating corpora for computational linguistics, speech recognition, machine translation and related fields. The system is configured with a feedback loop where annotation tools used by annotators are coupled to an online learning algorithm. The learning algorithm is used to incrementally update the corpus of a model, based on annotations contributed by the annotators. The system then uses the updated corpus to produce future annotations for data that the annotator still needs to annotate. A comparator module compares the result of the next annotation produced by the annotator with the annotation produced by the model. The GUI then selectively notifies the annotator of a possible inconsistency or mistake when the annotations produced by the annotator and by the model are different. The GUI provides UT elements for notifying the annotator of possible mistakes. The degree of selectivity is controlled by a contrast selector module. The GUI notifies the annotator when the confidence of the model on its produced annotation is sufficiently high. The system provides means for allowing the annotators to us a UI control to adjust the confidence threshold. Possible inconsistencies and mistakes below the threshold are not flagged, while those that are above the threshold are flagged.

A computer readable media having computer executable instructions for annotating corpora for computational linguistics, speech recognition, machine translation and related fields is presented. The computer readable media includes code for establishing annotation tools used by annotators and for inputting annotations to the learning algorithm. The model is incrementally trained by inputting the annotations produced by the annotator to the learning algorithm. The trained model outputs annotations for data that the annotator still needs to annotate. The computer readable media further includes code for comparing the result of the next annotation input from the annotator with the annotation output by the model. The annotator is notified of a possible inconsistency or mistake when the annotations input from the annotator and output by the model are different. The annotator is notified by UI elements. Such notifications result when the confidence of the model on its output annotation is sufficiently high. The computer readable media further includes code for displaying a UI control to the annotator. The control allows the annotator to tune a confidence threshold below which possible inconsistencies and mistakes are not flagged and above which they are flagged.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a graphical user interface (GUI) of an annotation system in accordance with the present principles;

FIG. 2 is a block/flow diagram showing steps in accordance with the present principles; and

FIG. 3 is a diagram showing system components in accordance with the present principles.

### DESCRIPTION OF EXEMPLARY EMBODIMENTS

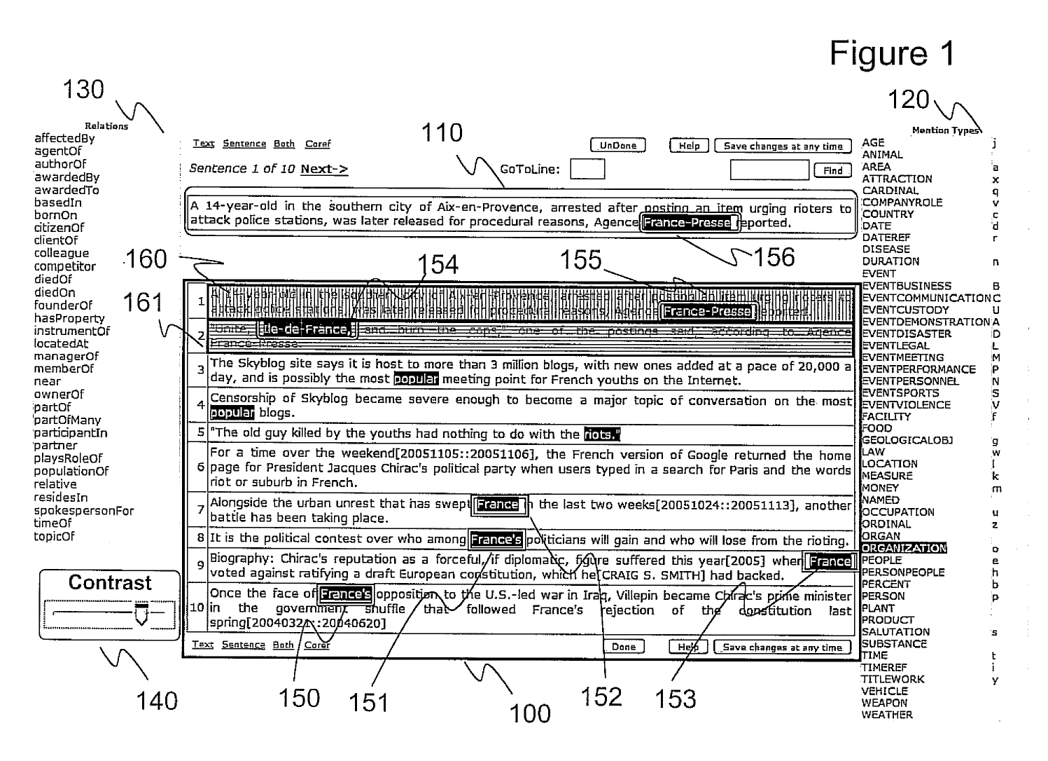

Referring to FIG. 1, a user interface of an annotation system for English text having features of the current invention is provided. The user interface displays a document 100 divided into sentences, identified by increasing integers. The currently selected sentence appears at the top (110). The GUI can be used to annotate entity mentions, using the palette 120 on the right hand side, and relations between entity mentions, using the palette 130 on the left hand side. The figure shows the GUI used to annotate entity mentions. In particular, the figure shows a scenario in which the annotator has marked mentions 150, 151, 152, 153, 154, and 155 as referring to the same referent, that is, to France (meant as a political entity, that is, as an organization rather than a geographical region). Of these, 154 and 155 (which also appears as 156 at the top) are annotation mistakes.

A model trained with an initial corpus and the annotation data produced by the annotator analyzes the current document. The annotations of the model and of the annotators are compared automatically; when they differ and the confidence of the model is higher than the threshold selected by the annotator via the “Contrast” control 140, the sentence containing the annotation is highlighted (sentence 1 (160) and 2 (161) in the figure). The higher the confidence of the model, the brighter the color used for highlighting. For example, the model is more confident that the annotation in 161 is incorrect than the annotation in 160. The vertical cross-hatching of section 160 represents a different highlight than the horizontal cross-hatching of section 160. For example, the degree of contrast or the visualization level, can be presented by varying the color, hue, saturation or other display characteristic of the section. The visualization can be presented in a range of pink colors. A light pink represents a small exceed value, with the pink becoming gradually more saturated or intense, with a bright pink representing a large exceed value. When the user views sections 160 and 161, it is immediately apparent that the brighter, more color saturated, section represents proportionally greater exceed value. The contrast control 140 adjusts the brightness or color saturation for all displayed inconsistencies. Each annotator can independently control the contrast 140, to alter the confidence threshold selectivity of the model via the user interface (UT) 130. This alters the visualization level of agreement between the respective annotator and the model, as described above and shown in sections 160 and 161.

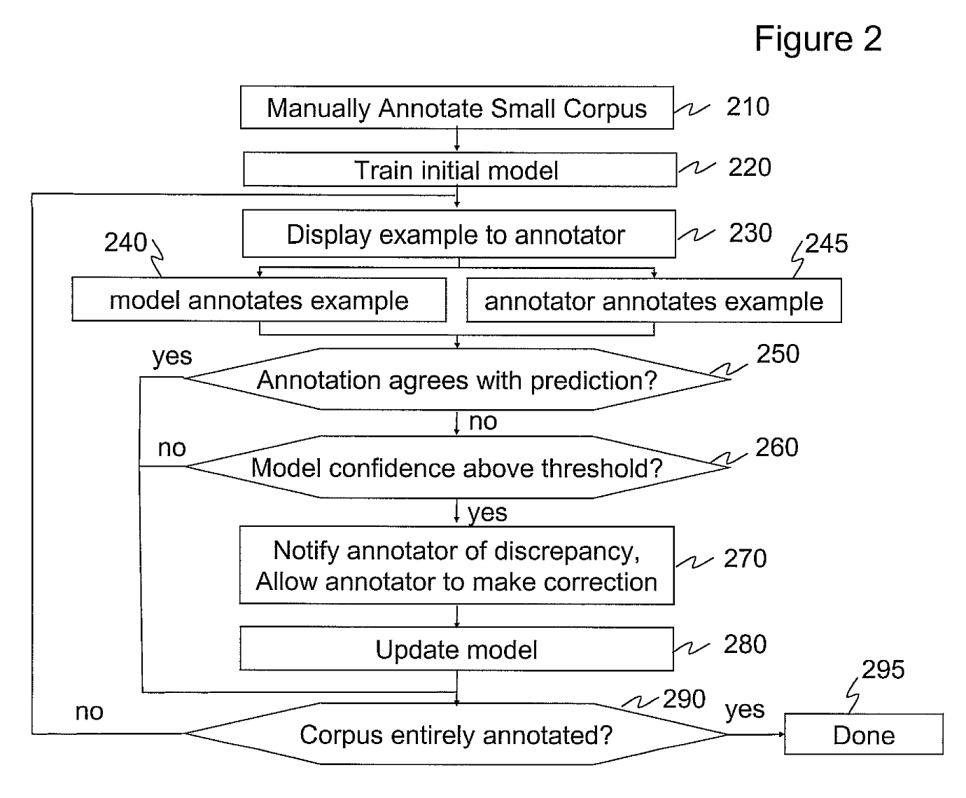

Referring to FIG. 2, a preferred embodiment of the present invention is described by means of a block diagram. The flow begins at step 210, where an initial corpus is manually annotated, that is, sections are annotated by one or more human annotators, using techniques and tools known in the art. It is important, albeit not essential to the present invention, that the annotation of the initial corpus be of high quality, which can be achieved with techniques described in the prior art section. Due to the elevated cost of these techniques, the initial corpus will be perforce of small size. It is also important, albeit not essential to the present invention, that the small corpus be selected carefully, to contain heterogeneous examples. The annotated corpus is then used to train an initial model in step 220, using techniques known in the art. The technique used to train the initial model is not important from the viewpoint of the present invention, provided that the trained model can be subsequently updated incrementally or retrained in real time.

Steps 230 to 295 describe a preferred embodiment of a model-driven feedback loop for producing consistent annotation between multiple human annotators using a single, automatic model. In step 230, an example to be annotated is presented to the annotator. For example, step 230 consists of displaying a document partitioned into sentences, as shown in the GUI of FIG. 1. Steps 240 and 245 are conceptually executed in parallel and separately. Their actual order does not affect the operation of the present invention. In Step 240, the current model automatically annotates the example. Concurrently and independently the annotator annotates the example in step 245. When both the annotations produced by the current model in step 240 and by the annotator in step 245 are available, the computation continues with Step 250 as described below. The granularity at which examples are annotated is not mandated in the present invention. In a preferred embodiment, both annotator and model annotate an entire document, and the annotator's annotations become available when the annotator clicks, for example, a “submit” button or equivalent control, to denote that annotation of the document has been accomplished. In a different preferred embodiment, both annotator and model annotate a sentence at a time, and the annotator's data becomes available when the annotator starts annotating the next sentence or when the annotator clicks a “submit” button or equivalent control, to denote that the annotation of the entire document is complete.

In step 250 the annotations produced by the annotator are compared to the annotations produced by the current model. The details of the comparison depend on the actual annotation task in a fashion that would be obvious to one of ordinary skills in the art. For example, consider the task of annotating mentions that have already been detected, as in FIG. 1; for this task, the comparison step consists of comparing for each of the mentions the annotation produced by the model and by the annotator.

If the comparison between the annotator's annotation and the model prediction is successful, the computation continues with step 290, as described below. Otherwise, the computation continues with step 260, where the confidence of the model on its prediction is compared to a threshold. Modern statistical models produce a confidence score or a posterior probability estimate for the prediction; it is also common to produce such a score or probability for the other possible prediction values. In a preferred embodiment, the confidence score or posterior probability estimate of the predicted value is compared to a threshold value, irrespective of the annotation produced by the annotator. In another preferred embodiment, the difference between the score of the predicted value and the score of the annotation produced by the annotator is compared to the threshold value. In the former embodiment, the comparison step only accounts for how confident the current model is of having produced the correct annotation; in the latter embodiment, the emphasis is on “how willing” the current model would be to discard its own annotation and accepting the annotation produced by the annotator. If the comparison of Step 260 fails, the computation continues from step 290, as described below. Otherwise, the computation continues from step 270.

In step 270 the annotator is notified of possible errors or inconsistencies in the produced annotations. In a preferred embodiment, the notification is performed using visual cues on the application GUI. Such visual cues include changing the background color of the sentences containing the annotation flagged as potentially inconsistent or erroneous; changing the color, face, and/or font of said sentence; opening a pop-up balloon or tooltip with a textual description of the problem near said sentence; or other means for displaying visual cues on the application GUI. After being notified of the problem, the annotator can decide to update the annotation or to leave it unchanged.

In step 280, the current model is updated using the annotations produced by the annotator in Step 245 and potentially updated in step 270. In a preferred embodiment, the model is updated using an incremental learning algorithm, such as the Voted Perceptron by Freund, or an instance-based learning algorithm, such as the k-nearest-neighbor algorithm described in Dasarathy. In another preferred embodiment, the model is rebuilt from scratch using a quick learning algorithm, such as the Naïve Bayes algorithm, described in Rish.

The computation of steps 230 to 280 iterates over all examples in the corpus. Step 290 controls the termination of the computation: if all examples in the corpus have been annotated, the computation proceeds to the terminating step 295, otherwise it goes back to step 230.

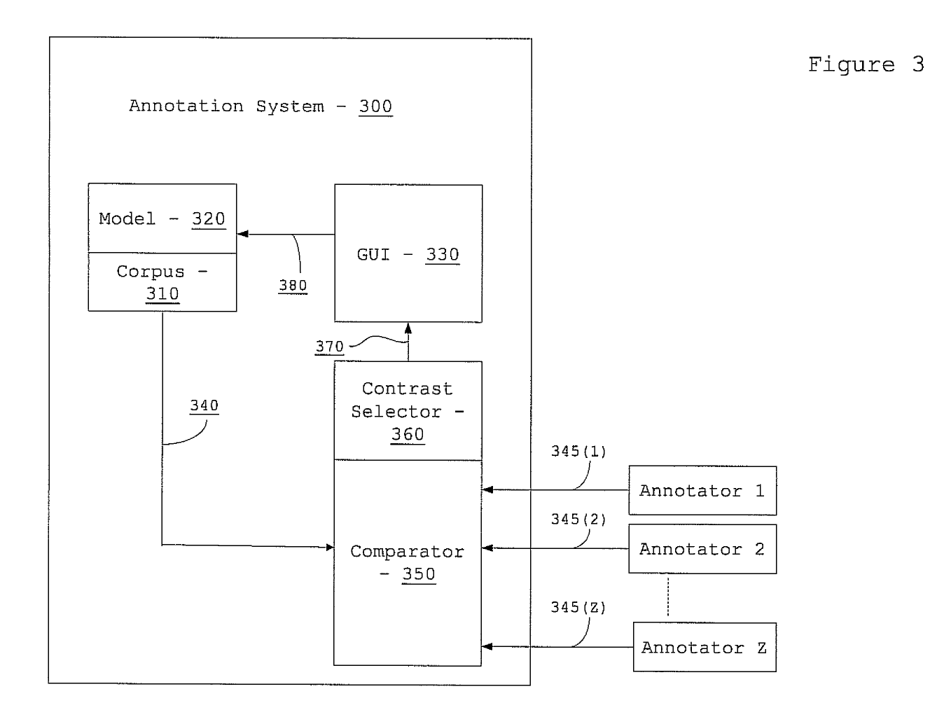

A diagram showing logical components of an embodiment of the inventive system is presented in FIG. 3. The annotation system 300 includes a combination of hardware and software elements that interact with one or more human annotators, represented by Annotator block 1, Annotator block 2, through Annotator block Z. Initially, a small corpus 310 is utilized to train a model 320.

When operating as a model-driven feedback system, a portion of the corpus 310 is displayed to the annotator via a Graphical User Interface (GUI) (330), for example a video type display, which may include a mouse-driven pointer or touch screen. A single, automatic model 320 annotates the examples as illustrated by connecting arrow 340. The one or more annotators annotate different parts of the corpus, as illustrated by connecting arrows 345(1), 345(2), through 345(z). The comparator 350 compares the model's annotation 340 with the human annotator's annotation, for example, that of annotator 345(2). If there is agreement, the model will display the next example to that annotator 345(2) via GUI 330.

If the model's prediction is different from the annotator's annotation, the system employs the contrast selector 360, which contains a user defined threshold. If the model's prediction possesses a confidence level above the threshold, the annotator is notified of the discrepancy by a posting via GUI 370. Slight discrepancies may be communicated 370 for display via GUI 330 with a first visual indication. That is, discrepancies which are slightly above the threshold. Gross discrepancies may be displayed by a second visual indication. That is, discrepancies which are far above the threshold. The first and second visual indications may be selected from a palette, where, for example, the higher the confidence of the model, the brighter the visual indication. Accordingly, the displayed visualization level is proportional to the value by which the prediction exceeds the selected threshold, that is, the exceed value. By adjusting the confidence threshold selectivity, the human annotator controls both the confidence level of predictions that are not flagged and the visualization level of those predictions that are flagged. In this way, the visualization level is gated by, and related to, the threshold by the exceed value.

After being notified of a discrepancy, the annotator will have an opportunity to accept the model's prediction, or override by updating the annotation. After model 320 is updated 380, such updated model is made available to all annotators. The arrows 340, 370 and 380 represent a feedback loop to update the single model for producing consistency between multiple annotators. The updated model is made available in near- or real-time. The updating 380 may employ an incremental learning algorithm, such as Voted Perceptron, or instance-based learning algorithm, such as the k-nearest-neighbor algorithm, or is rebuilt using a quick learning algorithm, such as Naïve Bayes algorithm.

It should be understood that the elements shown in FIGS. 1-3 may be implemented in various forms of hardware, software or combinations thereof. Preferably, these elements are implemented in software on one or more appropriately programmed general-purpose digital computers having a processor and memory and input/output interfaces.

Embodiments of the present invention can take the form of an entirely hardware embodiment, an entirely software embodiment or an embodiment including both hardware and software elements. In a preferred embodiment, the present invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

This invention teaches a method for providing model-driven feedback to multiple annotators. In a preferred embodiment, multiple annotators perform annotation tasks on different parts of a corpus. A single model is used for providing feedback to all annotators as described in FIG. 2. This single model is initialized as described in steps 210 and 220 of FIG. 2. The model is updated as in step 280 whenever annotated data becomes available from any of the annotators. In a preferred embodiment, the updated model becomes immediately available to all annotators. In a different preferred embodiment, each annotator has a cached copy of the model, which is updated when the processing for that annotator reaches step 290.

In a preferred embodiment of the present invention, the confidence threshold is controlled by the annotator using an appropriate GUI element, such as a slider, a radio button, or analogous controls. The GUT element can be used to set a value of the threshold or can be operated during annotation to visualize the level of agreement between the annotator and the model.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims.

Having thus described aspects of the invention, with the details and particularity required by the patent laws, what is claimed and desired protected by Letters Patent is set forth in the appended claims:

1. A method for producing consistent annotation between multiple human annotators using a single, automatic trained model, comprising:
providing different parts of a corpus stored in memory on an annotation system to multiple human annotators to perform annotations thereon;
identifying potential inconsistencies between the annotations made by each of the human annotators and annotation predictions made by a single, automatic model, wherein the single, automatic model is stored in memory on an annotation system and performs annotation predictions using a processor;
allowing each human annotator to independently control the confidence threshold selectivity of the model via a user interface (UI) to alter the visualization level of agreement between the respective annotator and the model;
notifying the human annotator of an inconsistency, if the confidence of the prediction exceeds the selected threshold, with a visualization level proportional to the exceed value;
allowing each human annotator to review and independently revise the inconsistency identified by the automatic model; and
updating the model based on the revisions and immediately making the updated model available to all human annotators.
